(19) United States
(12) Patent Application Publication
(10) Pub. No.: US 2021/0182875 A1
(43) Pub. Date: Jun. 17, 2021

(54) Globalization, Localization, and Internationalization Learning and Regulation Model

(71) Applicant: Dell Products L.P., Round Rock, TX (US)

(72) Inventors: Rathi Babu, Bangalore (IN); Mainak Roy, Kolkata (IN)

(73) Assignee: Dell Products L.P., Round Rock, TX (US)

(21) Appl. No.: 16/710,592

(22) Filed: Dec. 11, 2019

(51) Int. Cl. G06Q 30/02; G06F 16/951; G06F 40/30; G06Q 10/06

(52) U.S. Cl. CPC G06Q 30/0201; G06Q 10/067; G06F 40/30; G06F 16/951

(57) ABSTRACT

A system, method, and computer-readable medium are disclosed for a learning and regulation model that supports globalization, localization and internationalization. Language files are identified from different platforms, wherein the language files are directed to particular products and/or services. The language files are retrieved and stored and periodically updated. Semantic files area created based on the language files. Business specific reports are created from the semantic files. Data us derived for particular products/services by allowing business units to define parameters/variables based on criticality and obligation and can be taken over a period of time.

### RELATED APPLICATIONS

This application is related to U.S. patent application Ser. No. 16/270,185, filed Feb. 7, 2019, and is incorporated herein by reference.

### BACKGROUND OF THE INVENTION

### Field of the Invention

The present invention relates to the management of information handling systems. More specifically, embodiments of the invention provide a system, method, and computer-readable medium for a learning and regulation model that supports globalization, localization and internationalization.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The widespread availability of such information handling systems has been instrumental in the adoption of social media into the mainstream of everyday life. Social media commonly refers to the use of web-based technologies for the creation and exchange of user-generated content for social interaction. An increasingly popular use of social media is to provide a channel for customer feedback and support. One aspect of customer support is understanding or knowing product/service-related issues which can be disseminated through files/data posted on various social media environments and platforms, including business-controlled sites, such as support or technical sites.

As businesses become more global, significant resources are invested for globalization, localization and internationalization of product/service-related content so that information goes to the larger global audience. Businesses are challenged to determine if the resources are effectively being used for the correct set of languages, assuring that based on globalization, localization and internationalization that the content is ready to serve the proper audience. Although customization of products and/or services of businesses can rely on regions and demographics, native languages can be a critical differentiator. A determinative factor for businesses is how well are native languages used in supporting products and/or services. For example, better customer support is realized when using native languages for the customer audience. Challenges include tracking multilingual data (e.g., metadata) periodically when such data is received from different regions/countries via different platforms (e.g., business support sites, social media sites, etc.), using updated data for further analytical studies, making decisions for a specific business unit based on the synthesized data, etc.

### SUMMARY OF THE INVENTION

A system, method, and computer-readable medium are disclosed for a learning and regulation model that supports globalization, localization and internationalization. Language files/data that are directed to particular products/services are identified from different platforms. The language files/data files are analyzed with predefined cross checked values defined by a particular business unit, where the predefined cross checked values are directed to variations in files/data as to languages. Semantic files/data are created based on the analyzed language files/data files. Reports specific to products/services of the particular business unit based on the created semantic files/data. Furthermore, data is derived from the generated reports for particular products/services specific to the particular business unit.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of a learning and regulation model that supports globalization, localization and internationalization;

FIG. 3 is a simplified block diagram of a system that supports learning and regulation model that supports globalization, localization and internationalization;

FIG. 4 is a generalized flowchart regarding updating language or semantic files/data; and

FIG. 5 is a generalized flowchart regarding a learning and regulation model that supports globalization, localization and internationalization.

### DETAILED DESCRIPTION

A system, method, and computer-readable medium are disclosed for a learning and regulation model that supports globalization, localization and internationalization. Globalization commonly referred to as “G11N” in the industry includes internationalization, translation and localization. In order to bring products and/or services to a global market and reach a global audience, the product and/or services are provided for different locales. Internationalization commonly referred to as “I18N” in the industry is a process of developing source code according to international languages. Localization commonly referred to as “L10N” in the industry is a process of integrating translation back into source code or original file format and creating a final output. Included herein are descriptions related to a deep dive/learning of data to arrive at accurate information that shows gaps in languages related to a business/business unit. Data variation are identified, and the variation can help improve the business with an unbiased conclusion. Implementations can include an improved information handling system that synthesizes data periodically, where the period of synthesizing can be controlled by the business/business unit.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

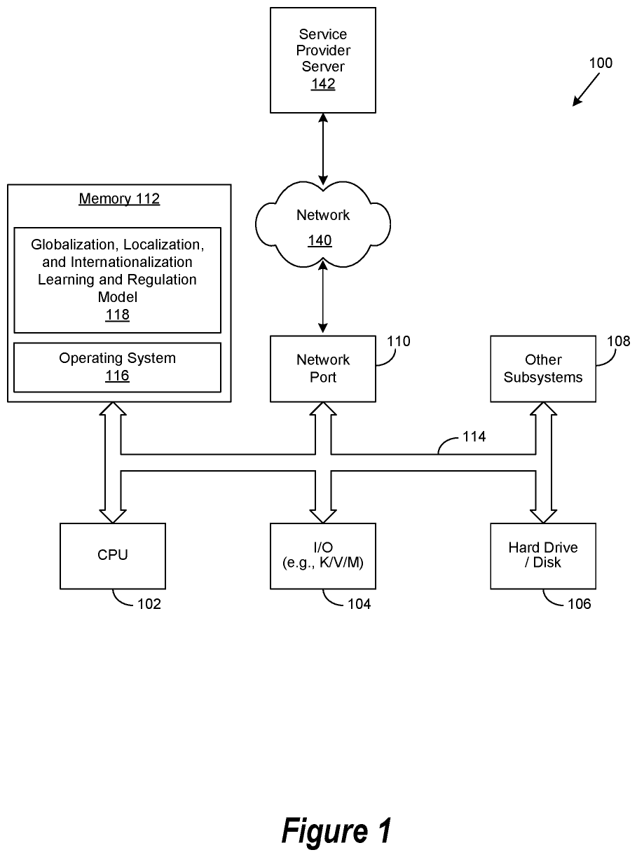

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a Globalization, Localization, and Internationalization Learning and Regulation Model (GLI LR Model) 118. In an embodiment, the information handling system 100 is able to download the GLI LR Model 118 from the service provider server 142. In another embodiment, the GLI LR Model 118 is provided as a service from the service provider server 142.

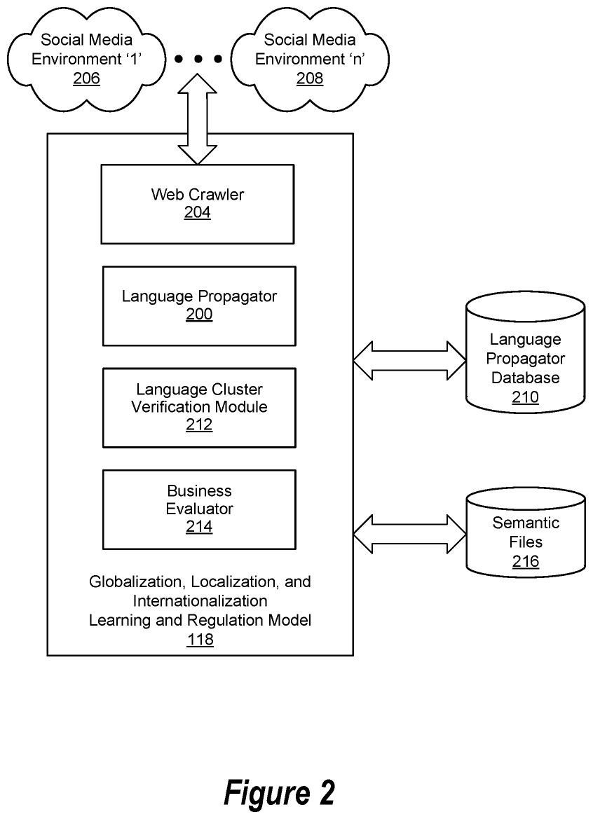

FIG. 2 is a simplified block diagram of a Globalization, Localization, and Internationalization Learning and Regulation Model implemented in accordance with an embodiment of the invention. As further discussed, the GLI LR Model 118 can be considered as an undeviating revision model that provides for correction factors that allow business units to define input values.

In certain embodiments, the GLI LR Model 118 includes a language propagator module 200 that includes a web crawler 202. In certain implementations, the web crawler 202 is configured to crawl/search language files/data that are posted on various sites and platforms as represented by social media environment ‘1’ 206 to social media environment ‘n’ 208, which can include business support sites, business technical centers, social media platforms external to the business, social media platforms internal to the business, etc. In particular, files/data related to products and/or services to a business/business unit are searched by web crawler 202. In certain implementations, the language that is used for the files/data can be identified using a language application program interface (API).

In certain implementations, the language propagator module 200 identifies product/service specific key phrases, hashtags (#tags), product/service identifiers, and other features that create unique identities for products and/or services provided/supported by the business/business unit. The language propagator module 200 initiates the web crawler 202, which identifies and monitors sources (i.e., social media environment ‘1’ 206 to social media environment ‘n’ 208) of different language or semantic files/data as related to particular products and/or services. In certain implementations, the language propagator module 200 enters such product/service specific language or semantic files/data into a language propagator database 210. In certain implementations, the language propagator database 210 is updated periodically. The language propagator database 210 stores the product/service specific files/data. The language propagator database 210 further can store product/service specific keyphrases, #tags, and the key features through which the product/service can create particular identity.

In certain implementations, using the data or product/service specific language or semantic files/data stored in the language propagator database 210, a language cluster verification module 212 is used to identify relationships of the data as to languages, region, and country. For example, the language cluster verification module 212 can be used to identify region, and different languages that are used by a specific region/country. Furthermore, the data can be segregated as to different product/services or business units. Other information that can be identified includes the number of times related information is downloaded or viewed from a specific site and other relevant data. In certain implementations, an analytics application, such as Google® Analytics or Omniture® Site Catalyst can be implemented to identify such data sets or clusters. The data sets can be verified against predefined product/service identifiers/values stored in the language propagator module 200.

In certain implementations, data sets that are verified by the language cluster verification module 212 are used by a business evaluator module 214. In particular, language clusters or languages used in a region/local can be consumed/used by the business evaluator module 214. Business units of a business can have different requirements when determining language sets for the particular business activities. Parameters can vary for the particular current and upcoming products/services, supported by the business units. In certain implementations, the business evaluator module 214 generates intermediate language or semantic files/data for particular business units and product lines and/or services supported by the particular business units. Such language or semantic files/data can include more granular/detailed data respective to a particular business unit.

Since language or semantic files/data are dynamic or continuously changing in nature, the language or semantic files/data can be updated by the language propagator module 200 as the language propagator module 200 fetches or finds a new incident for a product and/or service, whether that language for the file/data is a current language or new language. The new incident can be across the different sites and platforms social media environment ‘1’ 206 to social media environment ‘n’ 208. Semantic files can keep updated data for business units, and there can multiple fragments of data which are product/service driven under a semantic file. In certain instances, there may be a few fragments that are updated over a period of time. Whenever there is a new release for a particular product and/or service, the language propagator module 200 and language cluster verification module 212 collect and upgrade the related data fragments.

In certain implementations, the language or semantic files/data can be stored in a semantics files database 216. In certain instances, there can be multiple fragments of data, or incomplete data, which are product/services driven under a language or semantic file/data. In certain cases, the fragments of data are updated over a period of time. Therefore, for certain implementations, whenever there is a new release for a particular product/service, the language propagator module 200 and language cluster verification module 212 can collect and upgrade the related fragments. Fragments of data can include information for different language sets, which combines data for different business unit driven variables.

Therefore, with implementation of the language propagator module 200, language cluster verification module 212, and business evaluator module 214, determination can be made as to how products and/or services are performing for particular regions, how local users/customers are accepting the products and/or services, different requirements of the various geographic locations (e.g., requirements based on search phrases, how user user/customer sentiments vary across the globe for the same product/service.

When a business/business unit analyzes a semantic file, business drive algorithms can be used for the entire set or fragments of the semantic file. In particular, if fragments of a semantic file, the analysis is performed for a particular version of a product or related service.

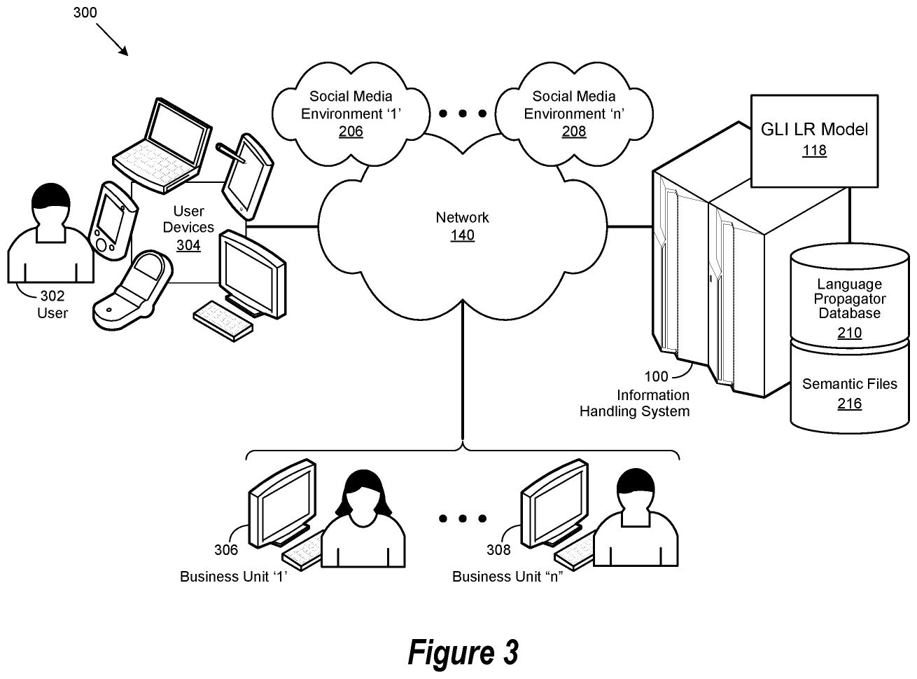

FIG. 3 is a simplified block diagram of a system 300 that supports learning and regulation model that supports globalization, localization and internationalization. In various embodiments, a user 302 may post a file/data to one or more of social media environment ‘1’ 206 to social media environment ‘n’ 208. The file/data can be language specific to the user 302, and particular to a region or country that the user 302 resides. Such a file/data can include product specific inquiries, comments, reports, repair requests, etc.

As used herein, a user device 304 refers to an information handling system such as a personal computer, a laptop computer, a tablet computer, a personal digital assistant (PDA), a smart phone, a mobile telephone, or other device that is capable of communicating and processing data. In various embodiments, the user device 304 is used to exchange information between the user 302 and one or more of social media environment ‘1’ 206 to social media environment ‘n’ 208 through the use of a network 140. In certain embodiments, the network 140 may be a public network, such as the Internet, a physical private network, a wireless network, a virtual private network (VPN), or any combination thereof. Skilled practitioners of the art will recognize that many such embodiments are possible, and the foregoing is not intended to limit the spirit, scope or intent of the invention.

In certain implementations, the GLI LR Model 118 included on information handling system 100 to monitor interactions conducted within a target social media environment ‘1’ 206 to social media environment ‘n’ 208 that may provide a file/data. In various embodiments, the information handling system 100 may include repositories/databases language propagator database 210 and semantics files database 216. The language propagator database 210 stores the product specific files/data. The language propagator database 210 further can store product/service specific keyphrases, #tags, and the key features through which the product/service can create particular identity. As discussed, the language or semantic files/data can be stored in a semantics files database 216. In certain instances, there can be multiple fragments of data, or incomplete data, which are product driven under a language or semantic file/data. In certain cases, the fragments of data are updated over a period of time.

In these various embodiments, the network 140 is used by the GLI LR Model 118 to monitor the social media environment ‘1’ 206 to social media environment ‘n’ 208 language or semantic files/data.

The GLI LR Model 118 then determines which business unit or units, such as a business units ‘1’ 306 through ‘n’ 308, will be responsible or have interest as to particular data sets of language or semantic files/data. In certain instances, the business units ‘1’ 306 through ‘n’ 308 are business evaluators, which use the data sets of language or semantic files/data, for business analytics. Examples of such analytics include periodically monitoring how information is consumed in different native languages/country and regions via different platforms; customization of a language set based on a sustainable data set; determining new regions and markets based on use of particular languages; propagating information in different languages to reach more customers; reducing the number of support calls, etc.

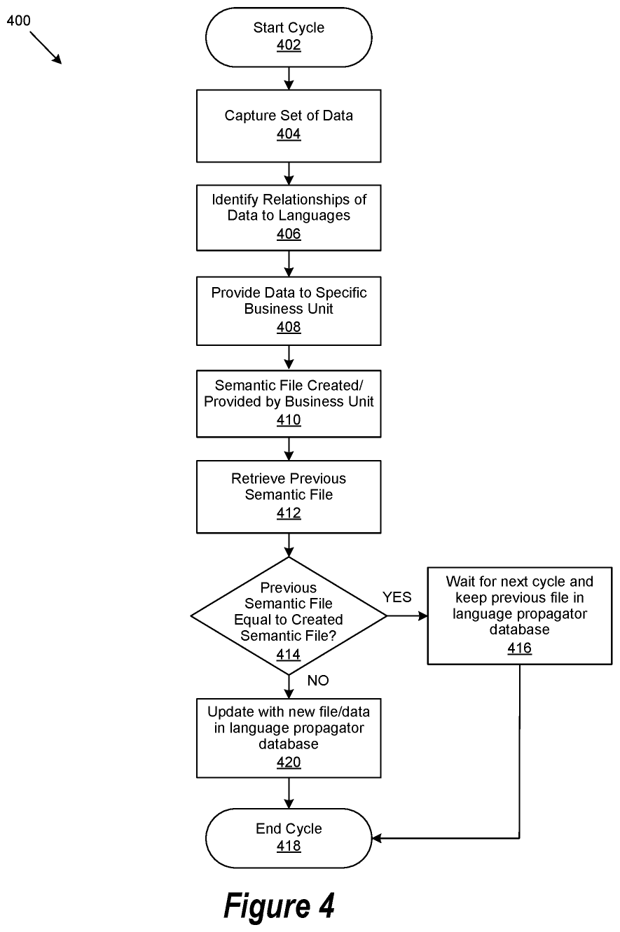

FIG. 4 is a generalized flowchart 400 regarding updating such language or semantic files/data. The order in which the method is described is not intended to be construed as a limitation, and any number of the described method blocks may be combined in an y order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

As discussed above, language or semantic files/data are dynamic or continuously changing in nature. In certain implementations, a predefined/predetermined cycle or period is used as to when a searching for language or semantic files/data is performed. In other implementations, searching for language or semantic files/data is continuous or does not have a set cycle. As discussed, the language or semantic files/data can be product related. Also, in certain cases, language or semantic files/data can be related to services that are provided. As also discussed, data sets of language or semantic files/data can be incomplete or fragmented. Furthermore, as discussed there are instances of product updates which affect related language or semantic files/data.

For this implementation, at step 402, a cycle is started. As discussed, for other implementations, flowchart 400 can be performed periodically or whenever it is determined that an update to language or semantic files/data are available. At step 404, new data sets of language or semantic files/data are captured. In certain implementations, the language propagator module 20 initiates the web crawler 202 to perform such a capture.

At step 406, the data sets are processed, identifying relationships of data to languages. In certain implementations, the processing is performed by the language cluster verification module 212.

At step 408, the data sets are associated with and provided to particular business units. In certain implementations, the business evaluator module 214 performs the association.

At step 410, particular language or semantic files/data are generated for particular business units. At step 412, previous semantic files/data are retrieved. At block 414, particular business unit language or semantic files/data are compared as to previous versions and recent or new versions, a determination is performed if the previous version of the language or semantic file/data is the same as the recent or new version. If the determination is “YES” at block 414, then at step 416, the previous language or semantic file/data is kept, and a wait is performed for the next cycle. At step 418 the cycle ends. If the decision is “NO” at block 414, then at step 420, the updated language or semantic file/data is kept. At step 418 the cycle ends. In certain implementations, the language or semantic file/data is stored in the language propagator database 210.

As discussed above, the business units ‘1’ 306 through ‘n’ 308 can be business evaluators, and through the Globalization, Localization, and Internationalization Learning and Regulation Model (GLI LR Model) 118 allows a particular analysis desired by a business unit.

Examples of business analysis (analytics studies) that can be performed using such a Globalization, Localization, and Internationalization Learning and Regulation Model (GLI LR Model) 118 with correction factors include, determining how products perform in a various regions/countries, determining how local user are accepting such products based on usage pattern of the local user language, determining the different requirements for different geographic regions, determining variations of global sentiments regarding the products, etc.

In certain implementations, a business unit of business units ‘1’ 306 through ‘n’ 308 receives a language or semantic file/data for analysis and can apply business driven algorithms to the entire data set. The same business driven algorithms can be applied to fragments of such a language or semantic file/data, such as if the requirement is to a particular version of a product. Different businesses or business units can have different requirements, such as commercial requirements. For analytics studies, customized reports can be generated based on the needs/requirements of a business or business unit.

A business or business unit can desire to observe the trend of certain variables over a period of time to determine anomalies or trends that impact the business or business unit. The variables can be business unit specific. Such anomalies or trends can be negative or positive. Such a business analysis can be also be a projection. In certain implementations, threshold parameters can be set for the variables, which are set/determined by the business or business units. A variable can be set, while other variables chosen/changed by the business or business unit. For example, to provide a comparison as to how certain variables can affect revenue, the variable “revenue” may be set, while other variables, such as “matched speaking language”, “number of downloads (of file/data)”, “number of views (of file/data)”, etc. In certain implementations, the business evaluator 214 performs such an analysis.

A variable which is important for a particular business unit may not have significant influence for the other business units. Therefore, business units can define and adjust variables based on their needs.

In certain implementations, the variables can have threshold or predefined limit/value. The threshold or predefined limit/value can be set by the business or business. Factors in setting the threshold or predefined limit/value include product maturity. The variables, also known as parameters, can have a weighted average, or correction factor. For example, the following can be used to determine weighted averages for variables.

The weighted average formula is used to calculate the average value of a particular set of numbers with different levels of relevance. The relevance of each number is called its weight. The weights should be represented as a percentage of the total relevancy. Therefore, all weights should be equal to 100%, or 1.

Weighted AVGx=w1x1+w2X2+ . . . wnxn
Weighted AVGx represents a specific result for a particular business or business unit
w=related weighted %
x=value for specific business unit

Each variable is treated a as a separate entity and represented by w. The related weighted average can be controlled by the business or business entity, where “w1” represents the revenue driven data which remains fixed for a business unit, and “x” defines the actual value for that variable on a given instance.

Trends can be determined for specific variables. Each variable has its own threshold value “v.” For example, set “n” to define the time period in months. Therefore, a determination is made to see how a variable performs. If the trend is sustained for a determined period of time, the business unit can accept the variable value and can use such values to plan for business activities, such as budgets, based on the specific set of variables, where the set of variables present different language variables/parameters for global, local, and international optimization.

The following formula may be use to plot different variables against time.

∫₁ⁿv1=dy/dz(α)

Where y=variation for a particular month, z=avg variation for the same variable across the entire timeline, and α=permitted correction factor for a variable, the value can be defined by the business for every individual variable.

As discussed, the variable “revenue” is set. Reports can be generated based on a revenue driven model, while certain selection criteria that can be implemented, such as number of users for different languages, the top number (e.g. top 10) languages that are used, and other criteria. Reports can be generated based on the business driven variables or parameters. As discussed, the variable “revenue” is selected to determine how a business or business unit is doing. Other variables can be changed to see the effect on “revenue”, where other variables can include “matched speaking language”, “number of download for product related information”, “number of views or interactions on the content”, etc. The model further allows, businesses and business units to create their own variables. Business or business units are provided the ability to customize specific variables based on business targets and to define related weighted variables. Business reports can show how current data sets deviate from a weighted average and impacts on businesses.

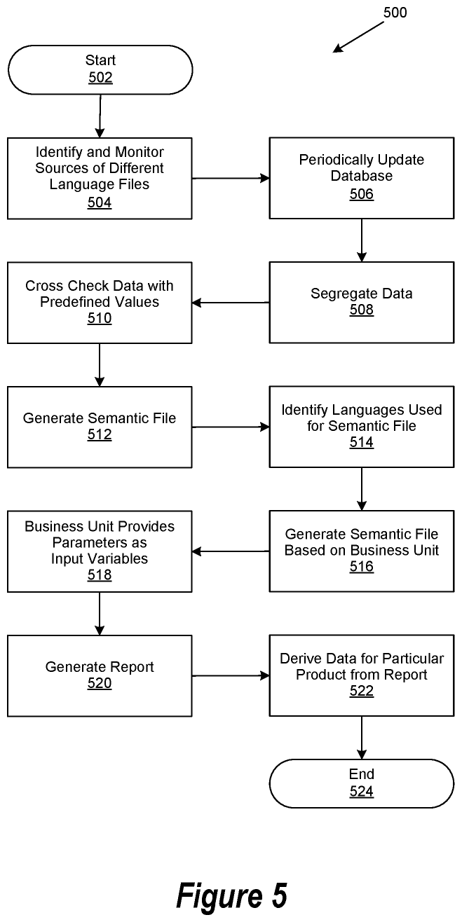

FIG. 5 is a generalized flowchart of the performance of operations implemented in accordance with an embodiment of the invention to implement a learning and regulation model that supports globalization, localization and internationalization.

The order in which the method is described is not intended to be construed as a limitation, and any number of the described method blocks may be combined in an y order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 502, the process 500 begins. At step 504, different language files/data are identified and monitored. The different language files/data can be from various sites, such as social media environments that include business support sites, business technical centers, social media platforms external to the business, social media platforms internal to the business, etc. The monitoring can be directed to files/data that are specific to a particular countries/regions and languages that are used. The information or data is identified as to language, region, country. The information or data can be furthered identified by specific products or services provided by a business or business unit.

At step 506, a language propagator database stores the product specific files/data and can be periodically updated. In certain implementations, particular business units request for the periodic updating. At step 508, data segregation is performed. The segregation can be directed to different product or business units. Other information that can be identified includes the number of times related information is downloaded or viewed from a specific site and other relevant data.

At step 510, the data is cross checked with any predefined values. In particular, a deep dive analysis of the data showing gaps/variations of languages used. The data variation can help improve the business metrics with an unbiased conclusion. The analysis can be performed periodically, where the period can be controlled by the business/business unit. The predefined values can be set by particular business units and provided by the language propagator module.

At step 512, semantic files are generated. At step 514, an association is performed as to languages used for different countries/regions for a specific semantic file/data.

At step 516, semantic files are generated for a specific business/business unit. At step 518, a business unit can provide parameters that are specific/critical for the particular business unit as input variables. At step 520, reports are generated for the specific business/business unit. Since requirements can be different for different businesses, customized reports for the analytics study can be created to provide a custom regulation model for the business/business unit. All products/services related to the business/business unit can be provided in the report. At step 522, data/information is derived for a specific product(s)/service(s). At block 524, the process 500 ends.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for globalization, localization and internationalization of a learning and regulation model comprising:
identifying language files/data from different platforms, wherein the language files/data are directed to particular products and/or services;
analyzing the language files/data files with predefined cross checked values defined by a particular business unit, wherein the predefined cross checked values are directed to variations in files/data as to languages;
creating semantic files/data based on the analyzed language files/data files;
generating reports specific to products/services of the particular business unit based on the created semantic files/data; and
deriving data from the generated reports for particular products/services specific to the particular business unit.

2. The method of claim 1, wherein the identifying language files/data is performed by web crawler implemented by a language propagator.

3. The method of claim 1, wherein the analyzing is performed periodically as defined by a business unit.

4. The method of claim 1, wherein the creating the semantic file comprises identifying relationships with languages, regions, and countries.

5. The method of claim 1 further comprising performing business analytics on the semantic files/data.

6. The method of claim 5, wherein the business analytics are directed to language and region specific variables.

7. The method of claim 5, wherein the business analytics are specific to a business unit.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for globalization, localization and internationalization of a learning and regulation model and comprising instructions executable by the processor and configured for:
identifying language files/data from different platforms, wherein the language files/data are directed to particular products and/or services;
analyzing the language files/data files with predefined cross checked values defined by a particular business unit, wherein the predefined cross checked values are directed to variations in files/data as to languages;
creating semantic files/data based on the analyzed language files/data files;
generating reports specific to products/services of the particular business unit based on the created semantic files/data; and
deriving data from the generated reports for particular products/services specific to the particular business unit.

9. The system of claim 8, wherein the identifying language files/data is performed by web crawler implemented by a language propagator.

10. The system of claim 8, wherein the analyzing is performed periodically as defined by a business unit.

11. The system of claim 8, wherein the creating the semantic file comprises identifying relationships with languages, regions, and countries.

12. The system of claim 8 further comprising performing business analytics on the semantic files/data.

13. The system of claim 12, wherein the business analytics are directed to language and region specific variables.

14. The system of claim 12, wherein the business analytics are specific to a business unit.

15. A non-transitory, computer-readable storage medium embodying computer program code, the computer program code comprising computer executable instructions configured for:
identifying language files/data from different platforms, wherein the language files/data are directed to particular products and/or services;
analyzing the language files/data files with predefined cross checked values defined by a particular business unit, wherein the predefined cross checked values are directed to variations in files/data as to languages;
creating semantic files/data based on the analyzed language files/data files;
generating reports specific to products/services of the particular business unit based on the created semantic files/data; and
deriving data from the generated reports for particular products/services specific to the particular business unit.

16. The non-transitory, computer-readable storage medium of claim 15, wherein the identifying language files/data is performed by web crawler implemented by a language propagator.

17. The non-transitory, computer-readable storage medium of claim 15, wherein the analyzing is performed periodically as defined by a business unit.

18. The non-transitory, computer-readable storage medium of claim 15, wherein the creating the semantic file comprises identifying relationships with languages, regions, and countries.

19. The non-transitory, computer-readable storage medium of claim 15 further comprising performing analytics on the semantic files/data.

20. The non-transitory, computer-readable storage medium of claim 19, wherein the business analytics are directed to language and region specific variables.
